(19) United States
(12) Patent Application Publication
(10) Pub. No.: US 2020/0192743 A1
(43) Pub. Date: Jun. 18, 2020

(54) SYSTEMS AND METHODS FOR COLLABORATIVE DIAGNOSIS AND RESOLUTION OF TECHNOLOGY-RELATED INCIDENTS

(71) Applicant: JPMORGAN CHASE BANK, N.A., New York, NY (US)

(72) Inventors: Leanne HARPER, Lewisville, TX (US); Jessie RINCON-PAZ, Wallis, TX (US); Richard A. PAVLOVSKY, Cypress, TX (US); Richard Harry DERBYSHIRE, Hong Kong (HK); Gary KIRBY, Verwood (GB); David M. GERBEREUX, North Brunswick, NJ (US); John STAPEY, Ayr (GB); Mark C. FULLAM, Bournemouth (GB); Brian Sean O'NEAL, Lutz, FL (US); Martin J. GRANT, JR., Middletown, DE (US)

(21) Appl. No.: 16/668,616

(22) Filed: Oct. 30, 2019

Related U.S. Application Data
(60) Provisional application No. 62/779,196, filed on Dec. 13, 2018.

(51) Int. Cl. G06F 11/07; G06Q 10/00; G06Q 30/00; G06F 9/451; G10L 15/26

(52) U.S. Cl. CPC G06F 11/0793; G06Q 10/20; G10L 15/26; G06F 9/453; G06Q 30/016

(57) ABSTRACT

Systems and methods for collaborative diagnosis and resolution of technology-related incidents are disclosed. In one embodiment a method may include: receiving an incident report for an incident; identifying a plurality of participants to involve in resolution of the incident; generating a technology incident workspace comprising an incident timeline module, a participant module, and a dynamic chat module; linking electronic devices associated to the technology incident workspace; logging the incident in the incident timeline module; receiving and logging chat among the participants in the dynamic chat module; generating a status indicator for the incident based on a severity of the incident, an anticipated time to resolution, and an impact of the incident, and displaying the status indicator in the technology incident workspace; receiving an update to the status indicator; and updating the timeline incident module based on a change in the status indicator.

### RELATED APPLICATIONS

This application claims priority to, and the benefit of, U.S. Provisional Patent Application Ser. No. 62/779,196, filed Dec. 13, 2018, the disclosure of which is hereby incorporated, by reference, in its entirety.

### BACKGROUND OF THE INVENTION

### 1. Field of the Invention

The present disclosure generally relates to systems and methods for collaborative diagnosis and resolution of technology-related incidents.

### 2. Description of the Related Art

In modem information technology (IT) environments, it often takes significant time to diagnose and resolve technical incidents or problems that arise across an organization's IT infrastructure. For instance, a large organization may employ hundreds or thousands of employees, with each employee having unique and complex IT-related needs. Organizations typically rely on multiple levels of IT support, starting with an initial “help desk” to gather information, identify and log IT issues. As more information about an issue is gathered, the support required to resolve an issue may be escalated to higher levels of IT support in order to facilitate the resolution of the issue.

For critical systems or services, interrupted service may result in significant financial loss or decreased productivity for the organization. Many systems are often interconnected with dependencies within multiple levels of the IT infrastructure. Thus, the impact of the interruption of a core service may be multiplied throughout the organization. Resolving complex technical issues often requires collaboration between multiple support parties or users, often across multimedia platforms, such as voice, chat, or video. Facilitating such collaboration can be burdensome on IT support resources, further adding to the amount of time it takes to resolve the initial technology incident. Furthermore, known support systems fail to adequately provide sufficient details relating the status of an incident, often creating duplicate or redundant support assignments or similar inefficiencies. For the IT support professionals responsible for the diagnosis and resolution of technology-related incidents, minimizing service interruption and maximizing the efficiency of incident resolution is paramount.

### SUMMARY OF THE INVENTION

Systems and methods for collaborative diagnosis and resolution of technology-related incidents are disclosed.

In an exemplary embodiment, a system for diagnosing and resolving technology-related incidents is provided. An exemplary system comprises a modular technology incident workspace comprising at least an incident timeline module configured to generate and display a chronological list of a plurality of incident events; a participant module configured to display user identifiers associated with a plurality of users, wherein the plurality of users comprises at least a workspace user and an incident support user; a dynamic chat module configured to facilitate communication between at least two of the plurality of users; and, a diagnosis module configured to generate and display a status indicator associated with a technology incident.

Further aspects of an exemplary system may include a roles and escalation module configured to assign roles to at least one of the plurality of users; a level set module configured to generate and display a live feed of resolution progress updates; an impacts module configured to generate and display a live feed of affected business units; and a workstreams and tasks module configured to generate and display assigned incident resolution tasks.

In another exemplary embodiment, a computer implemented method of diagnosing and resolving technology-related incidents is provided. The method comprises receiving an incident report from a server; generating a modular technology incident workspace, wherein the modular technology incident workspace comprises at least an incident timeline module configured to generate and display a chronological list of a plurality of incident events; a participant module configured to display user identifiers associated with a plurality of users, wherein the plurality of users comprises at least a workspace user and an incident support user; a dynamic chat module configured to facilitate communication between at least two of the plurality of users; and, a diagnosis module configured to generate and display a status indicator associated with a technology incident; logging an incident associated with the incident report via the incident timeline module; generating a dynamic chat connecting at least workspace user and an incident support user; generating and displaying at a status indicator associated with the incident associated with the incident report; updating the incident timeline module according to at least one change in the status indicator associated with the incident associated with the incident report.

In another embodiment, in an information processing apparatus comprising at least one computer processor, a method for diagnosing and resolving technology-related incidents may include: (1) receiving an incident report for an incident; (2) identifying a plurality of participants to involve in resolution of the incident; (3) generating a technology incident workspace comprising an incident timeline module, a participant module, and a dynamic chat module, wherein the timeline module generates and displays a chronological list of a plurality of incident events, the participant module displays identifiers associated with each of the plurality of participants, and the dynamic chat module is configured to receive chat from the plurality of participants; (4) linking electronic devices associated with the plurality of participants to the technology incident workspace; (5) logging the incident in the incident timeline module; (6) receiving and logging chat among the participants in the dynamic chat module; (7) generating a status indicator for the incident based on a severity of the incident, an anticipated time to resolution, and an impact of the incident, and displaying the status indicator in the technology incident workspace; (8) receiving an update to the status indicator; and (9) updating the timeline incident module based on a change in the status indicator.

In one embodiment, the incident report may be received from one of a system, a device monitoring a system, and from manual entry.

In one embodiment, the method may further include establishing an audio bridge number for an audio bridge.

In one embodiment, the method may further include converting audio from the audio bridge to text.

In one embodiment, the method may further include logging the text in the dynamic chat module.

In one embodiment, the method may further include logging at least one event associated with the incident in the dynamic chat module.

In one embodiment, the impact of the incident may be based on an impact to at least one of an impact on an organization and the organization's customers.

In one embodiment, the method may further include performing at least one post-incident action including at least one of conducting root cause analysis to identify and fix an underlying issue, identifying additional monitoring opportunities to detect the underlying issue, determining if the underlying issue could occur elsewhere in the environment based on a variety of attributes, identifying strategies to solve the underlying issue faster.

In one embodiment, the technology incident workspace may present a link to an electronic file relevant to the incident.

In one embodiment, the method may further include executing a bot to investigate the incident; and presenting the result of the investigation in the technology incident workspace.

According to another embodiment, a system for diagnosing and resolving technology-related incidents may include a plurality of participant electronic devices, and a server executing a technology incident workspace comprising an incident timeline module, a participant module, and a dynamic chat module, wherein the timeline module is configured to generate and display a chronological list of a plurality of incident events, the participant module is configured to display identifiers associated with each of the plurality of participants, and the dynamic chat module is configured to receive chat from the plurality of participants. The server may receive an incident report for an incident, may identify a plurality of participants to involve in resolution of the incident, and may generate the technology incident workspace. The technology incident workspace may link the participant electronic devices to the technology incident workspace, may log the incident in the incident timeline module; may receive and log chat among the participants in the dynamic chat module; may generate a status indicator for the incident based on a severity of the incident, an anticipated time to resolution, and an impact of the incident, and displaying the status indicator in the technology incident workspace; may receive an update to the status indicator; and may update the timeline incident module based on a change in the status indicator.

In one embodiment, the incident report is received from one of a system, a device monitoring a system, and from manual entry. The system may include one of a hardware system, a software system, and a services system.

In one embodiment, the technology incident workspace may establish an audio bridge number for an audio bridge with an audio bridge provider.

In one embodiment, the technology incident workspace may convert audio from the audio bridge to text. The technology incident workspace may log the text in the dynamic chat module.

In one embodiment, the technology incident workspace may log at least one event associated with the incident in the dynamic chat module.

In one embodiment an impact of the incident is based on an impact to at least one of an impact on an organization and the organization's customers.

In one embodiment, the technology incident workspace performs at least one post-incident action including at least one of conducting root cause analysis to identify and fix an underlying issue, identifying additional monitoring opportunities to detect the underlying issue, determining if the underlying issue could occur elsewhere in the environment based on a variety of attributes, identifying strategies to solve the underlying issue faster.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for collaborative diagnosis and resolution of technology-related incidents according to one embodiment;

FIG. 2 depicts an exemplary technology incident workspace is provided according to one embodiment;

FIG. 3 depicts an exemplary technology incident workspace is provided according to one embodiment; and

FIG. 4 shows an exemplary method for diagnosing and resolving technology-related incidents,

### DETAILED DESCRIPTION OF PREFERRED EMBODIMENTS

Embodiments are generally directed to systems and methods for collaborative diagnosis and resolution of technology-related incidents.

Embodiments are directed to systems and methods for collaborative incident management. In one embodiment, a collaborative incident management system may be provided to displays relevant information on a single pane or window where all parties involved in the management or resolution of the incident. The pane or window may include sub-windows or widgets that may be automatically updated as information related to the incident changes.

Embodiments may further provide an integrated feature chat room that may include automation and public chat capabilities, and may further include BOT usability. In embodiments, the contents of the chat room may be manually or automatically saved (e.g., as a PDF document) and stored for recordkeeping, privacy, audit, machine-learning purposes, etc.

In response to a technology incident (e.g., a major incident such as a customer-facing website going down), embodiments may provide a collaborative system, where individuals or parties to resolve the incident and individuals or parties that need to know of the status of the incident are provided with information in a pane or window. The individuals or parties may include technology personnel, business personnel, product owners, vendors, etc.

The technology incident may be reported manually, by an automated agent that monitors the system(s) having the technology incident, potentially as a result of systematically generated events found through alerting.

In response to a technology incident being reported, in embodiments, a command center may be notified that may generate an incident ticket. This generation may be done manually, automatically, or a combination of both.

In one embodiment, machine learning may be used at several stages, including decisioning on whether to generate an incident ticket.

In response to the generation of the incident ticket, embodiments may notify a response team, which may include technologists, to resolve the incident. This may include opening a technology phone bridge by which the technologists may communicate. In embodiments, the system may automatically call the technologists from the technology phone bridge.

Embodiments may also notify individuals and/or lines of business that may be impacted by the technology incident. This may include opening a business phone bridge by which the business individuals may communicate. In embodiments, the system may automatically call the business individuals from the business phone bridge.

Embodiments may further provide notifications (e.g., email, SMS, push, etc.) to notify other individuals of the technology incident.

Embodiments may open a chatroom, by which technologists may communicate regarding the attempts to resolve the technology incident. In one embodiment, the communications on the technology phone bridge and/or the business phone bridge may be transcribed in real-time, or substantially in real-time, and added to the chat.

In one embodiment, bot automation may be used with the chatroom in order to facilitate the use of integrated tools. For example, if the resolution requires approval from a chat participant, the chat participant may indicate approval, and a bot may communicate the approval to one or more service so that the approval may be routed through that service. APIs and other interfaces may be used with bot automation as is necessary and/or desired.

In one embodiment, the contents of the chatroom may be stored for recordkeeping, audit purposes, etc. In one embodiment, the contents of the chatroom may be used with machine learning in order to assist with the resolution of future technology incidents.

Embodiments may further facilitate communication and/or use of other services to communicate. For example, a user may send an email, message, etc. through a separate service (e.g., an email server, message server, etc.) using the system, and embodiments may use an interface (e.g., an API) to communicate the message to the separate service.

The incident may be with any monitored systems, including hardware and software. In one embodiment, the systems for collaborative incident management may be executed by a server, and may communicate with the monitored system(s), services (e.g., approval services, messaging services, logging services, telephony services, etc.). In one embodiment, the system may integrate with other incident management systems, including third party systems.

In one embodiment, the method may be performed by an application or computer program. Individuals may interact with the system and method using any suitable interface, including computers, mobile devices, Internet of Things appliances, etc.

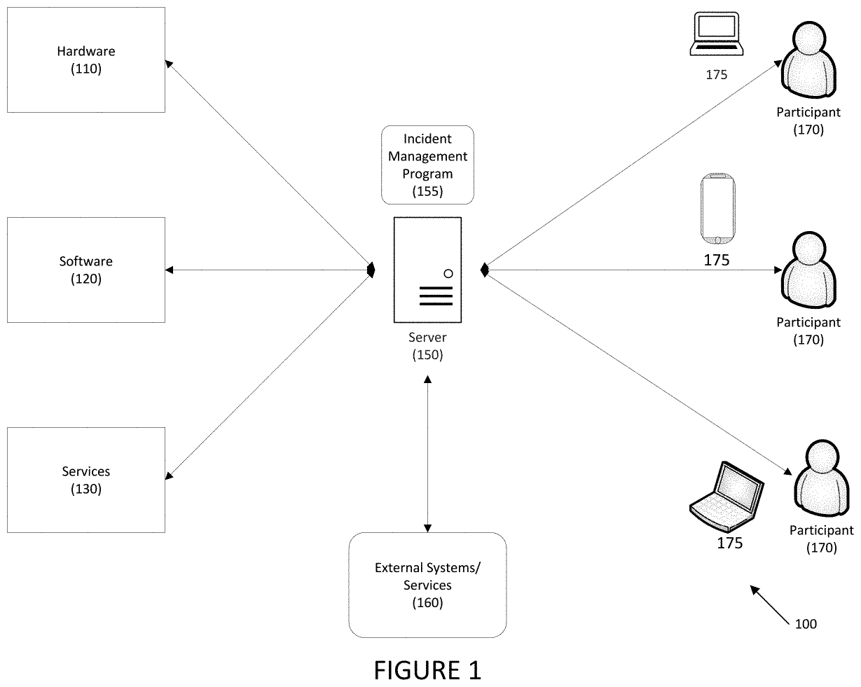

Referring to FIG. 1, a system for collaborative diagnosis and resolution of technology-related incidents is disclosed according to one embodiment. System 100 may include hardware 110, software 120, and services 130 that are being monitored.

It should be recognized that, for illustrative purposes, only one hardware element, software element, and service are provided in FIG. 1. A greater number of any hardware elements 110, software elements 120, and/or services 130 may be monitored as is necessary and/or desired.

Server 150 may execute incident management program 155, which may interface with hardware 110, software 120, and/or services 130. In one embodiment, hardware 110, software 120, and/or services 130 may be monitored by a local program (not shown), may be polled, etc. In one embodiment, one or more application programmable interface (API) may be provided.

Server 150 may be any suitable electronic device that may execute incident management program 155. In one embodiment, server 150 may include one or more local servers, one or more cloud providers, combinations thereof, etc.

Participants 170 may be any individuals that may be involved in the resolution of an incident, including resolving the incident, managing the resolution of the incident, and being informed of the status of the incident. Participants 170 may interface with incident management program 155 using electronic device 175, which may be any suitable electronic device including, for example, notebook computers, desktop computers, laptop computers, tablet computers, workstations, smart phones, smart watches, Internet of Things (IoT) appliances, etc.

In one embodiment, electronic devices 155 may interface with external systems/services 160. External systems/services 160 may provide, for example, chat functionality, voice bridge functionality, video bridge functionality, messaging (e.g., SMS) functionality, etc.

Incident management program 155 may provide an interface for participants 170 to monitor a technology-related incident on hardware 110, software 120, and/or services 130. In one embodiment, incident management program 155 may communicate updates in a chat window directly to participants 170, or indirectly through external systems/services 160. Incident management program 155 may further provide a graphical user interface that provides information on the incident, such as a current status, a timeline for the incident, a listing of participants 170, an incident manager (e.g., one of participants 170), as well as other information that will be discussed below.

Technology-related incidents may involve one or more computers, mobile devices, servers, or similar hardware products, as well as software products, such as programs, applications (or “apps”) managed or utilized by the organization, services provided by the organization, etc. The term technology-related incident or “incident” as used herein should not be construed as limited to the above examples and will be recognized by those of skill in the information technology arts.

Examples of technology-related incidents may include any problem or incident affecting an organization requiring a technical solution, including incidents covered by a Service Level Agreement (SLA) or similar contractual agreement wherein the organization is authorized and/or obligated to address and resolve incidents occurring outside of the organization. Obligations to parties outside the organizations covered by agreements such as SLA's may nevertheless be referred to herein as within the organization as their service obligation falls within the organization.

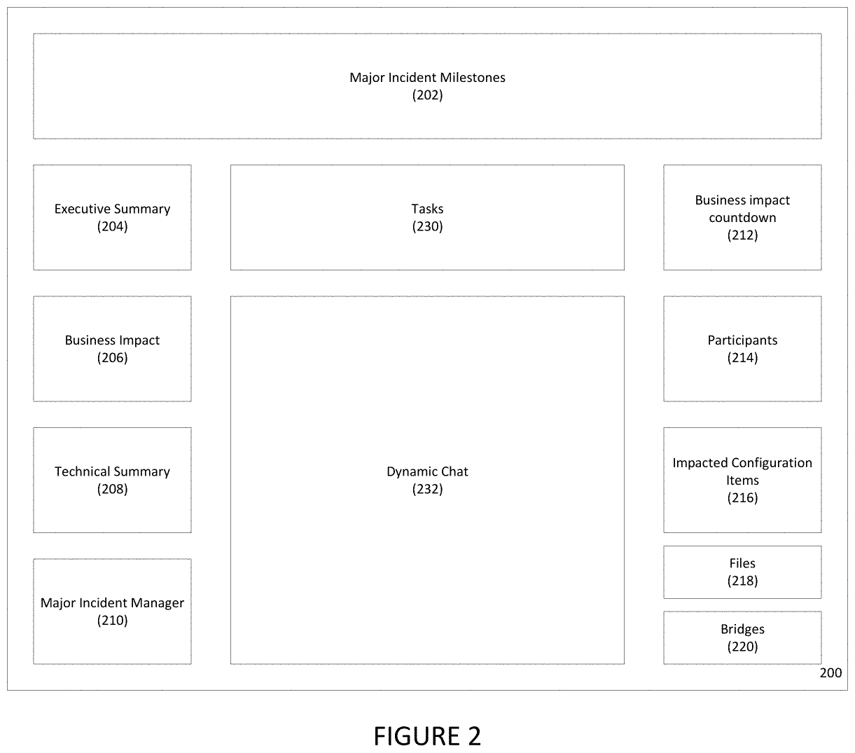

Referring to FIG. 2, an exemplary illustration of a technology incident workspace is provided according to one embodiment. Workspace 200 may include, for example, milestones module 202, executive summary module 204, business impact module 206, technical summary module 208, major incident manager module 210, business impact countdown module 212, participants module 214, impacted configuration items module 216, files module 218, bridges module 220, tasks module 230, and dynamic chat module 232. In embodiments, additional, different, or fewer modules may be provided as is necessary and/or desired.

The various modules of technology incident workspace 200 may be dynamically generated for display on a computer monitor or display. In some embodiments, technology incident workspace 200 may be configured for display on a mobile device such as a smart phone or tablet. Technology incident workspace 200 may be configured to dynamically organize modules according to the physical layout of the display or window of a display. For example, if the workspace display window is resized to be smaller, certain modules may autohide or minimize while others may stay “locked” in place. For example, if a user of modular technology incident workspace 200 resizes a window displaying modular technology incident workspace 200, modules may also be maximized or minimized according to user preference, or in some embodiments, according to module activity.

It will be further appreciated that the modules of the technology incident workspace 200 may be re-positioned manually by a user according to their preferences. In some embodiments, an organization may be saved and used by future users of the workspace.

In one embodiment, incident milestones module 202 may generate and display an incident timeline comprising technology incidents and other steps in resolving the incident. Milestones may include, for example, detected, which is the point which the technology organization becomes aware of the incident (monitoring, client reported, etc.); diagnosed, which is when the resolver group determines actions required to restore service; mitigated, which is when the technical problem is fixed (e.g., the failure has been permanently or temporarily resolved and service is available to customers, either via normal means, redundancy, or workaround); and resolved, which is when all downstream components (technology, operations, and applications) are recovered and all customer impacts have been mitigated. The times may be displayed in local user time.

In one embodiment, incident milestones module 202 may display an incident number and a ticket number. It may further provide a configuration item and short description for the incident.

In one embodiment, incident milestones module 202 may display a severity status. In one embodiment, the state may be described in color (e.g., (Blue, Yellow, Amber, Red), or by other differentiating means such as numeric (e.g., P1S1, P1S2, P1S3, etc.). The state may represent the amount of escalation and communication required for the incident.

Incident milestones module 202 may further communicate with reporting components, such as an incident ticketing system. In embodiments, incidents are reported through an online reporting portal. Incidents may be reported at the point of use by an end user, by an incident support user at the point of use, remotely by an incident support user, remotely by a workspace user, etc.

Incidents may also be event driven that may be reported automatically in response to a recognizable event. For example, when a server is offline for a predetermined amount of time, a ticket or report may be automatically generated and reported to milestones module 202 or other modules of technology incident workspace 200. In some embodiments, technology incident workspace 200 may be initialized for a workspace user upon receipt of an incident report.

In one embodiment, executive summary module 204 may provide a high-level overview of the incident. In one embodiment, executive summary module 204 may provide a non-technical explanation of the incident, may identify the problem the expected time to resolution, an estimation of required resources, an estimate of impacted systems, lines of business, etc.

In one embodiment, the executive summary may be automatically generated from an incident report. In other embodiments, an executive summary may be manually input by an incident manager.

In one embodiment, business impact module 206 may provide a description of the impact on an organization, its lines of business, its customers, etc. In one embodiment, business impact module may identify how the organization, line(s) of business, and/or customers are impacted.

Business unit information relating to the incident may include, for example, line of business, impact level, assigned resolution business unit, and assigned sub-business unit.

In one embodiment, technical summary module 208 may provide technical details about what failed, the root cause (if available), description of actions to mitigate impact (completed/current workstreams and outcomes), and a description of what is being done to prevent reoccurrence (if available).

In one embodiment, incident manager module 210 may identify the manager for the incident.

In one embodiment, business impact countdown module 212 may provide a countdown timer to business impacts identified by business impact module 206. This may indicate the urgency of the incident.

In one embodiment, colors may be used to indicate severity. For example, when the countdown is within 1 hour, the clock may turn amber. When the countdown is within 5 minutes, the clock may turn red. Other timings, colors, etc. may be used as is necessary and/or desired.

In one embodiment, a clock may be provided that provides a duration of the incident.

In one embodiment, participants module 214 may list the resources actively engaged in the management and resolution of the incident and their respective roles.

In one embodiment, impacted configuration items module 216 may display all configuration items that are impacted by the incident. Impacted assets may be required to be operationally online or back online before the incident can be resolved.

In one embodiment, files module 218 may provide links to the files that are relevant to the incident.

In one embodiment, bridges module 220 may identify information for one or more audio bridges (e.g., technical, business, management, etc.) related to the incident.

In one embodiment, tasks module 230 may display the tasks/workstreams for the incident. In one embodiment, the incident manager may create tasks, provide due date/time estimates, and may make updates based on the information entered in the chat by the resolvers.

In one embodiment, when the “Due In XX Minutes” portion is selected, hovered over, etc., the time may be displayed in the user's local time zone.

In one embodiment, dynamic chat module 232 may be specific to the incident and may be used to document the active discussions during the management of the incident. It provides a full history of the key events, questions, status, data, etc.

Dynamic chat module 232 may configured to facilitate communication between users, such as an end user, an incident support user, or a workspace user. Communication may include multimedia messages, include voice, video, or text data. In embodiments, dynamic chat module 232 may receive phone conversations or similar voice or video data, and may convert that data into text.

Users connected to dynamic chat module 232 may be displayed in participants module 214. Dynamic chat module 232 may automatically invite additional users to communicate via the chat module based on incident information, such as that appearing on incident timeline module 202.

In one embodiment, participants module 214 may display all users or parties connected to dynamic chat module 232. Users connected to dynamic chat module 232 may be identified as a participant or host. Other information describing the user, such as their job title, business unit, user ID, currently assigned incidents, currently assigned tasks, etc., may be displayed in participants module 214.

In embodiments, participants module 214 may suggest certain users to invite to a chat based on acquired incident information. A user may be suggested based on their availability or their organizational role.

In embodiments, dynamic chat module 232 may launch or execute additional programs or applications to further facilitate incident resolution, such as bots, dynamic widgets, etc. A bot or dynamic widget may perform tasks and display information in dynamic chat module 232 or elsewhere in the technology incident workspace 200. For example, a bot may be configured to run a server healthcheck to determine connectivity parameters related to servers affected by an incident. A bot may be further configured to engage, escalate, and/or update incident event information within incident timeline module 202.

In embodiments a bot may be configured as a “chatbot” operable to automatically assist with diagnosis of an incident. Bots may be further configured to execute commands locally or on a remote system. Dynamic chat module 232 may launch a bot or dynamic widget through an application programming interface (API) call or execution of an automated script. In certain embodiments, a bot or widget may be initialized through an outside connection to a third party or open source tool. In other embodiments, a bot or widget may be a proprietary implementation accessible only by authorized users within an organization.

In embodiments, dynamic chat module 232 may be a secure, cloud-based, communication and content sharing platform, such as Symphony.

Dynamic chat module 232 may include topology views of an organization's IT infrastructure. Topology views are dynamic and may change according to updated information received by the technology incident workspace 200. Topology views may be further configured to change according to alerts received from application and/or devices within an organization. A topology view may include certain visualizations related to data traffic, server health and connectivity, or the like. Topology views may also include business application views correlated other incidents within an organization. Disparate incidents may be correlated based on incident information available to the various modules of technology incident workspace 200 or configuration information used in configuring and initializing the workspace. For example, correlation of incidents may be determined according to IT infrastructure resource availability and performance, application availability, or change, performance, and capacity data. Correlation of disparate incidents may also be based on items or elements impacted by the incident being worked. The correlation may have a near real-time connection to correlation engines configured to associate an active incident to various databases such as, for example, a configuration database, an incident database, an availability database, a performance database, a capacity database, a risk database, a compliance management database, etc.

In one embodiment, as key events occur, a conscious effort must be made to record them into the chat. In another embodiment, events may be automatically added to the chat as they occur so that they are integrated into the timeline for the event. In one embodiment, the events may be added as timestamps.

In one embodiment, machine learning may be used to identify any events that are added to the chat.

In one embodiment, all individuals have access to update the chat, but only the incident manager(s) can update the other fields.

Embodiments may provide the ability to restrict access under certain conditions such as sensitive incidents. Access to the system could be controlled systematically through system role entitlements, or manually. The exemplary system may allow for inclusion of attachments of any type, such as scripts, documents in word, pdf, adobe, etc., or references to locations of attachments such as on share point, confluence, etc.

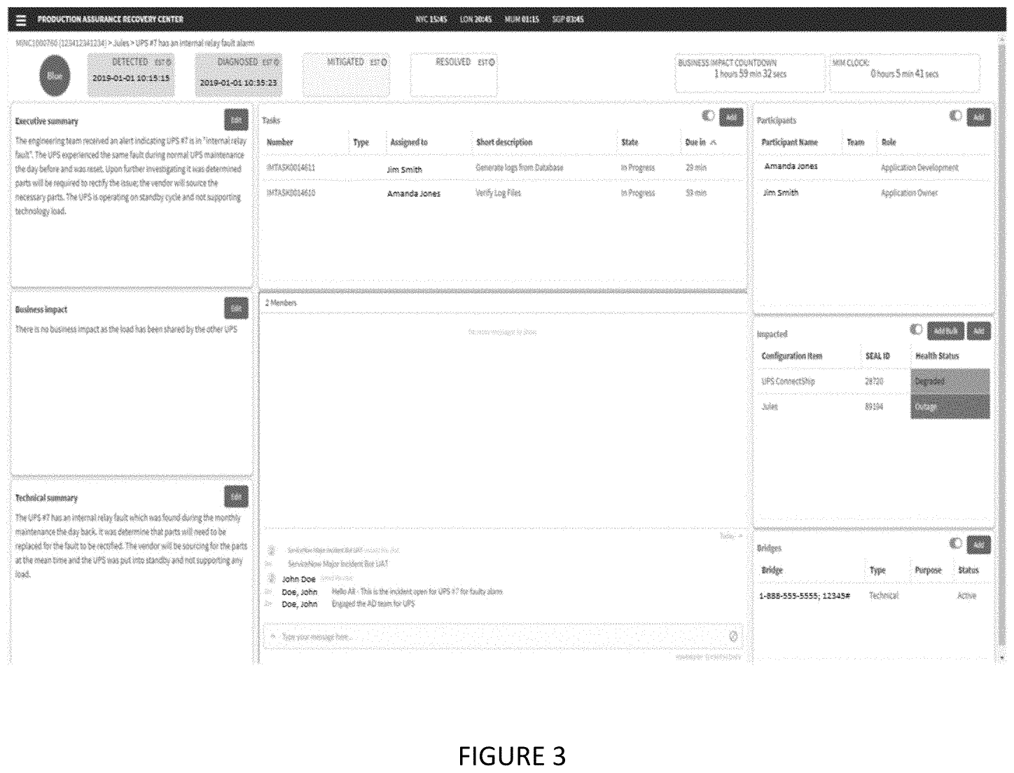

An exemplary technology incident workspace is provided as FIG. 3.

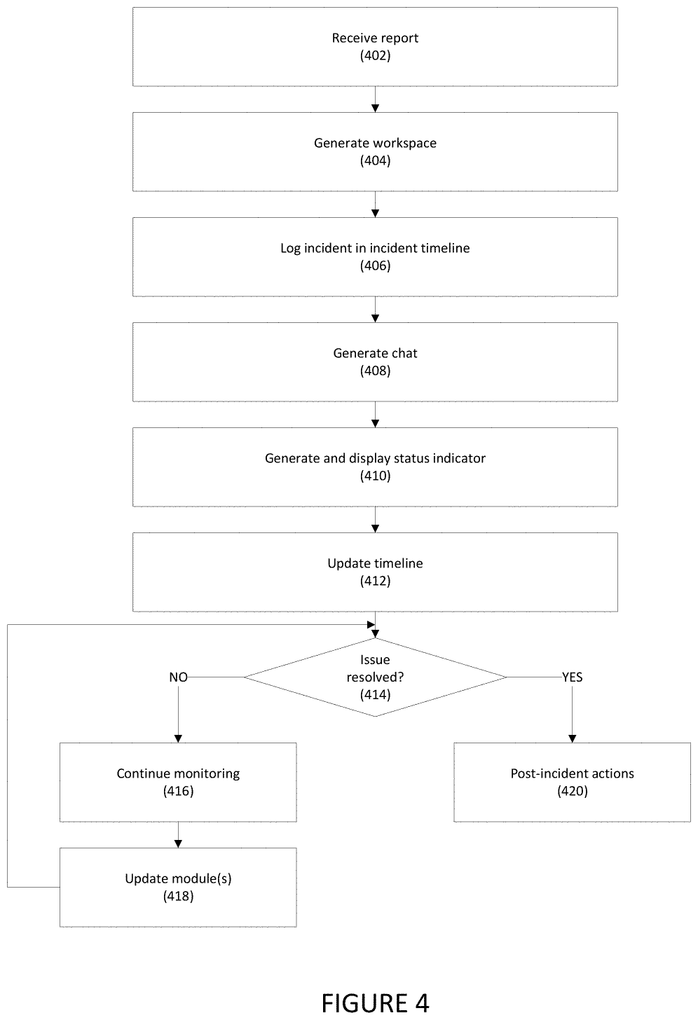

FIG. 4 shows an exemplary computer-implemented method for diagnosing and resolving technology-related incidents. In step 402, an incident report for an incident may be received. In one embodiment, the incident report may be received from a system, from a device monitoring a system, may be entered manually, may be based on a plurality of systems, etc.

In step 404, a technology incident workspace may be generated. In one embodiment, the technology incident workspace may include an incident timeline module that may generate and display a chronological list of a plurality of incident events, a participant module that may display user identifiers associated with a plurality of users, such as workspace users, an incident support user, etc., and a dynamic chat module that facilitates communication between at least two of the plurality of users. Other modules may be displayed as is necessary and/or desired.

In one embodiment, one or more audio bridges may be opened for audio communication, and the information necessary to access the bridges may be provided.

In step 406, an incident associated with the incident report may be logged via, for example, an incident timeline module.

In step 408, a dynamic chat connecting at least workspace user and an incident support user may be generated.

In one embodiment, audio from one or more of the bridge(s) may be converted to text and may be inserted into the chat. In one embodiment, as events relevant to the incident occur, the chat may be annotated with the occurrence of the event.

In step 410, a status indicator associated with the incident associated with the incident report is generated and displayed. In one embodiment, the status indicator may be based on the severity of the incident, the anticipated time to resolution, and/or the impact on the organization, lines of business, the users, and/or the organization's customers.

In step 412, the incident timeline module may be updated according to at least one change in the status indicator associated with the incident associated with the incident report.

In step 414, if the issue is not resolved, in step 416, the systems may be monitored, and in step 418, the modules may be updated as appropriate.

In 414, if the issue is resolved, in step 420, post-incident actions may be taken. Examples of post-incident actions may include conducting root cause analysis to identify and fix the underlying issue, identifying additional monitoring opportunities to detect the issue, determine if the same issue could occur elsewhere in the environment based on a variety of attributes, identifying strategies to solve this issue faster in future if it reoccurs, which may result in a reduction in the mean time to resolution, documenting after action reports, etc.

It should be recognized that although multiple embodiments are disclosed, they are not mutually exclusive, and feature from one may be applied to others.

Hereinafter, general aspects of implementation of the embodiments will be described.

Embodiments of the invention or portions of thereof may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for diagnosing and resolving technology-related incidents, comprising:
in an information processing apparatus comprising at least one computer processor:
receiving an incident report for an incident;
identifying a plurality of participants to involve in resolution of the incident;
generating a technology incident workspace comprising an incident timeline module, a participant module, and a dynamic chat module, wherein the timeline module generates and displays a chronological list of a plurality of incident events, the participant module displays identifiers associated with each of the plurality of participants, and the dynamic chat module is configured to receive chat from the plurality of participants;
linking electronic devices associated with the plurality of participants to the technology incident workspace;
logging the incident in the incident timeline module;
receiving and logging chat among the participants in the dynamic chat module;
generating a status indicator for the incident based on a severity of the incident, an anticipated time to resolution, and an impact of the incident, and displaying the status indicator in the technology incident workspace;
receiving an update to the status indicator; and
updating the timeline incident module based on a change in the status indicator.

2. The method of claim 1, wherein the incident report is received from one of a system, a device monitoring a system, and from manual entry.

3. The method of claim 1, further comprising:
establishing an audio bridge number for an audio bridge.

4. The method of claim 3, further comprising:
converting audio from the audio bridge to text.

5. The method of claim 4, further comprising:
logging the text in the dynamic chat module.

6. The method of claim 1, further comprising:
logging at least one event associated with the incident in the dynamic chat module.

7. The method of claim 1, wherein an impact of the incident is based on an impact to at least one of an impact on an organization and the organization's customers.

8. The method of claim 1, further comprising:
performing at least one post-incident action including at least one of conducting root cause analysis to identify and fix an underlying issue, identifying additional monitoring opportunities to detect the underlying issue, determining if the underlying issue could occur elsewhere in the environment based on a variety of attributes, identifying strategies to solve the underlying issue faster.

9. The method of claim 1, wherein the technology incident workspace presents a link to an electronic file relevant to the incident.

10. The method of claim 1, further comprising:
executing a bot to investigate the incident; and
presenting the result of the investigation in the technology incident workspace.

11. A system for diagnosing and resolving technology-related incidents comprising:
a plurality of participant electronic devices; and
a server executing a technology incident workspace comprising an incident timeline module, a participant module, and a dynamic chat module, wherein the timeline module is configured to generate and display a chronological list of a plurality of incident events, the participant module is configured to display identifiers associated with each of the plurality of participants, and the dynamic chat module is configured to receive chat from the plurality of participants;
wherein:
the server receives an incident report for an incident; the server identifying a plurality of participants to involve in resolution of the incident;
the server generates the technology incident workspace;
the technology incident workspace links the participant electronic devices associated with the plurality of participants to the technology incident workspace;
the technology incident workspace logs the incident in the incident timeline module;
the technology incident workspace receives and logs chat among the participants in the dynamic chat module;
the technology incident workspace generates a status indicator for the incident based on a severity of the incident, an anticipated time to resolution, and an impact of the incident, and displaying the status indicator in the technology incident workspace;
the technology incident workspace receives an update to the status indicator; and
the technology incident workspace updates the timeline incident module based on a change in the status indicator.

12. The system of claim 11 wherein the incident report is received from one of a system, a device monitoring a system, and from manual entry.

13. The method of claim 12, wherein the system comprises one of a hardware system, a software system, and a services system.

14. The system of claim 11, wherein the technology incident workspace establishes an audio bridge number for an audio bridge with an audio bridge provider. The system of claim 14, wherein the technology incident workspace converts audio from the audio bridge to text. The system of claim 15, wherein the technology incident workspace logs the text in the dynamic chat module.

17. The system of claim 11, wherein the technology incident workspace logs at least one event associated with the incident in the dynamic chat module.

18. The system of claim 11 wherein impact of the incident is based on an impact to at least one of an impact on an organization and the organization's customers.

19. The system of claim 11, wherein the technology incident workspace performs at least one post-incident action including at least one of conducting root cause analysis to identify and fix an underlying issue, identifying additional monitoring opportunities to detect the underlying issue, determining if the underlying issue could occur elsewhere in the environment based on a variety of attributes, identifying strategies to solve the underlying issue faster.
